(19) United States
(12) Patent Application Publication
(10) Pub. No.: US 2017/0352928 A1
(43) Pub. Date: Dec. 7, 2017

(54) Thermal Pocket for Securing Exothermic Devices and Mobile Device

(71) Applicant: Michael W. Lingenfelter, Selbyville, DE (US)

(72) Inventor: Michael W. Lingenfelter, Selbyville, DE (US)

(21) Appl. No.: 15/175,479

(22) Filed: Jun. 7, 2016

(51) Int. Cl. H01M 10/615; H01M 2/10; H01M 10/6595

(52) U.S. Cl. CPC H01M 10/615; H01M 10/6595; H01M 2/1022

(57) ABSTRACT

A pocket on or in a piece of apparel for carrying and storing a mobile phone or similar battery powered electronic device in cold temperatures is disclosed. An exothermic device is placed in proximity either within the same pocket compartment or in a separate pocket in close proximity. The heat generated by the exothermic device prevents battery degradation at these temperatures.

### BACKGROUND OF THE INVENTION

### Field of the Invention

The present invention relates generally to apparel and, more specifically, to an apparel pocket for securing an exothermic device and mobile electronic device together such that the exothermic device provides heat to prevent both damage to sensitive electronic components and to extend battery life by mitigating collapse of the battery chemical process due to use in extreme cold.

### Description of the Prior Art

There are other devices which provide for warming mobile devices. While these devices may be suitable for the purposes for which they where designed, they would not be as suitable for the purposes of the present invention as heretofore described.

It is thus desirable to provide articles with closeable pocket receptacle for a mobile device and an exothermic product.

It is further desirable to provide re-closeable pocket receptacle having one compartment for mobile device and another compartment for an exothermic device.

### SUMMARY OF THE PRESENT INVENTION

A primary object of the present invention is to provide articles of clothing or the like with a latchable and re-closeable pocket for the placement therein of an electronic device, such as a mobile phone, with the pocket potentially having another associated receptacle for the placement therein of an exothermic device that when activated will heat both the pockets.

Another object of the present invention is to provide a latchable pocket incorporated into articles selected from the group of apparel and backpack for storing a user provided mobile device and user provided exothermic device.

Yet another object of the present invention is to provide a latchable pocket having an interior and exterior layer wherein said exterior layer may be of the same material as the article of clothing (or backpack) that the pocket is attached to and where the interior layer may be manufactured from a heat reflective material.

Still yet another object of the present invention is to provide a latchable pocket having a mobile device compartment and an exothermic product compartment with the compartments sharing a common wall manufactured from a heat retentive material.

Another object of the present invention is to provide said latchable pocket wherein said latching is selected from zipper and Velcro®.

Additional objects of the present invention will appear as the description proceeds.

The present invention overcomes the shortcomings of the prior art by providing articles of clothing or the like with a pocket for securing a user provided exothermic device and user provided mobile electronic device therein and where the exothermic device provides heat to prevent damage to sensitive electronic components and extend battery life by mitigating collapse of the battery chemical process due to environmental extreme cold, such as when the user is snowboarding, skiing, ice climbing, etc.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### DESCRIPTION OF THE REFERENCED NUMERALS

Turning now descriptively to the drawings, in which similar reference characters denote similar elements throughout the several views, the figures illustrate the use of the present invention. With regard to the reference numerals used, the following numbering is used throughout the various drawing figures.
U user
10 skiing
12 outdoor events
14 snowmobiling
16 hunting
18 outdoor work
20 present invention
22 mobile (electronic) device
24 exothermic device (warmer)
26 peelable cover over adhesive surface
28 winter apparel
30 thermal pocket
32 electronic device and warmer
34 hook and loop fasteners
36 phone compartment
38 warmer compartment
40 zippered side pocket
42 zipper closure
44 second embodiment thermal pocket
46 second embodiment mobile device compartment
48 second embodiment warmer compartment
50 extra warmer compartment
52 releasable closure
54 top zipper closure
56 inner dividing compartment wall
58 parka pocket
60 breast phone pocket
62 breast warmer pocket
64 snap closure
66 vertically oriented phone pocket
68 horizontally oriented warmer pocket
70 parka zipper closures
72 snow pants
74 vertically oriented pant pocket
76 horizontally oriented pant pocket
78 pant zipper closures
80 snow pant pockets
82 backpack
84 backpack phone compartment
86 backpack warmer compartment
88 backpack zipper closures
90 backpack thermal pocket

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention in use.

FIG. 2 is a perspective view of mobile device with an attachable exothermic device.

FIG. 3 is a perspective view of mobile device having attached exothermic device.

FIG. 4 is an illustrative view of an enablement of the present invention in use.

FIG. 5 is an illustrative view of a thermal pocket for heating mobile device.

FIG. 6 is an illustrative view of an enablement of the present invention in use.

FIG. 7 is an illustrative view of the thermal pocket having a storage pocket for additional exothermic devices.

FIG. 8 is an illustrative view of the present invention in use.

FIG. 9 is an illustrative view of an enablement of the present invention in use.

FIG. 10 is an illustrative view of an enablement of the present invention in use.

FIG. 11 is an illustrative view of other winter apparel incorporating thermal pocket for mobile device.

FIG. 12 is an illustrative view of an additional element of the present invention in use.

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

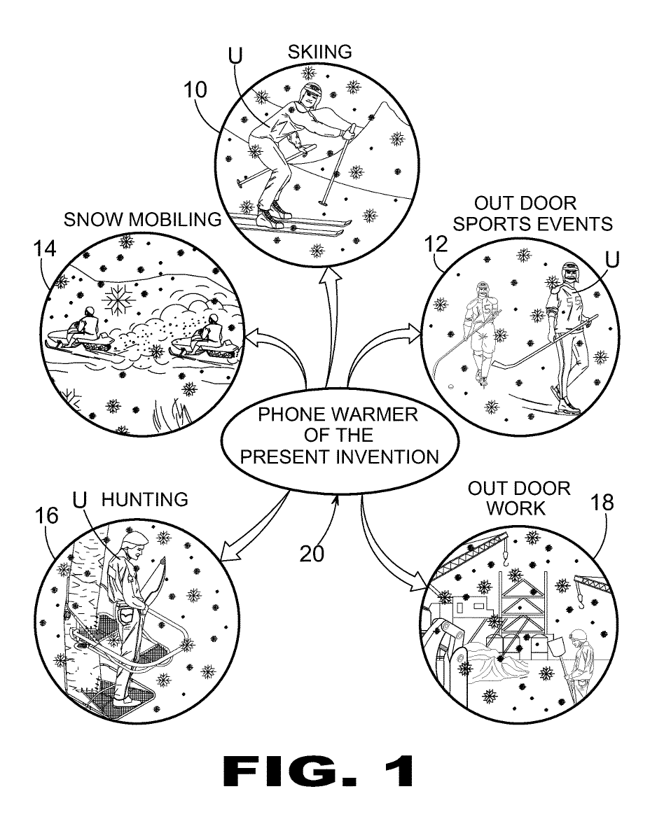

Referring to FIG. 1, shown is an illustrative view of the present invention in use. The present invention is a thermal pocket either attached to or integral with articles of clothing or the like for storing a user provided mobile device (or other battery operated electronics) and an exothermic device. The method of heating a cell or smart phone with an exothermic device may include packaging incorporating an adhesive layer with a peelably removable cover that once removed enables the exothermic device to be adhesively attached to the user provided mobile device. The present invention further envisions that the thermal pocket provides latchable closure sealing the heat and mobile device therein. These details will be explained further below. In the Figure, the user U is shown undertaking various activities. The activities shown include skiing 10, various outdoor events, such as sporting events, attended as either a participant or a spectator 12, snowmobiling 14, hunting 16, or merely being outdoors at work, construction work for example. It is well known that extreme cold, or merely long exposure to cold, shortens the battery life of a cell phone or the like. The present invention, indicated at 20, seeks to address this problem.

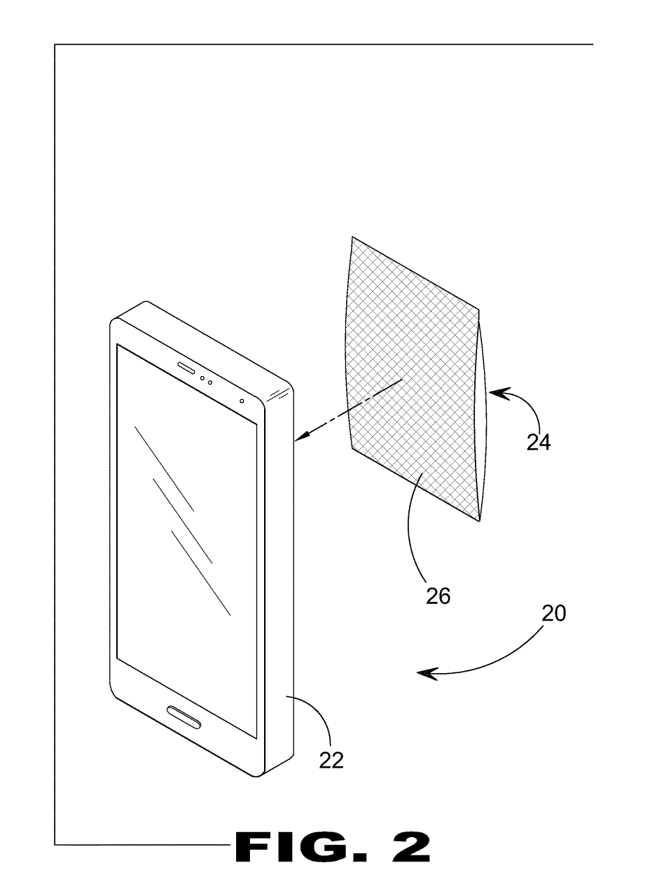

Referring to FIG. 2, shown is a perspective view of a mobile device 22 with an attachable exothermic device 24. Shown is an exothermic device 24 removed from its packaging and ready for use, the device 24 incorporating a peelably removable cover 26 that is located over an adhesive surface on the exothermic device 24. This allows the user to attach the exothermic device 24 to the battery powered electronic device 22 to prevent the failure or degradation of battery power due to cold.

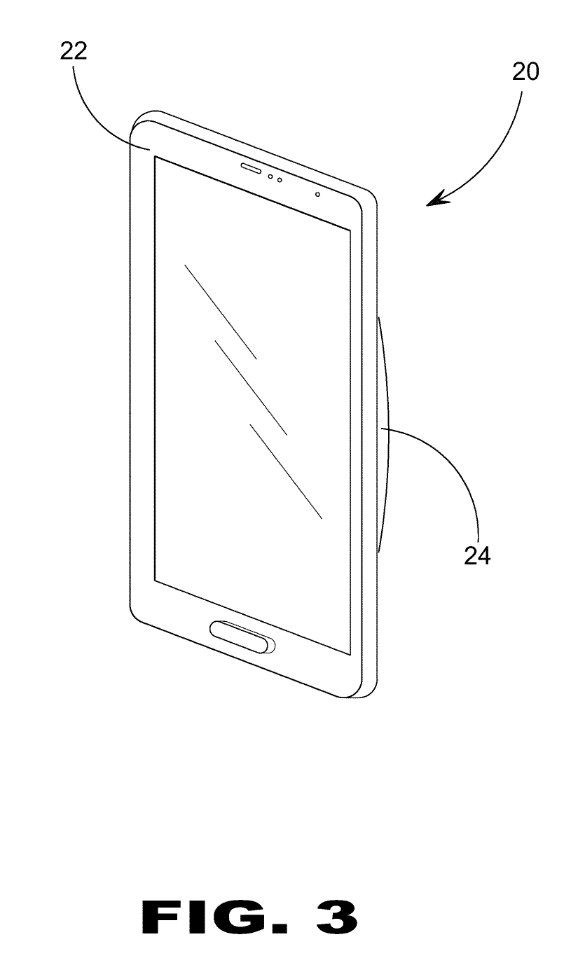

Referring to FIG. 3, shown is a perspective view of the present invention in use at 20. Shown is a mobile device 22 having with an attached exothermic device 24. The peelable cover 26 (seen in FIG. 2) has been removed and the warming unit (exothermic device) 24 has been adhesively attached to the battery powered device 22. The exothermic device could generate heat in a number of ways. It could, for example, be a combustion-based warmer, with fuel and a combustion chamber. It is contemplated, though, that a chemical mixture that when exposed to air produces heat could also be used. These types of devices are commonly known as “hand warmers”.

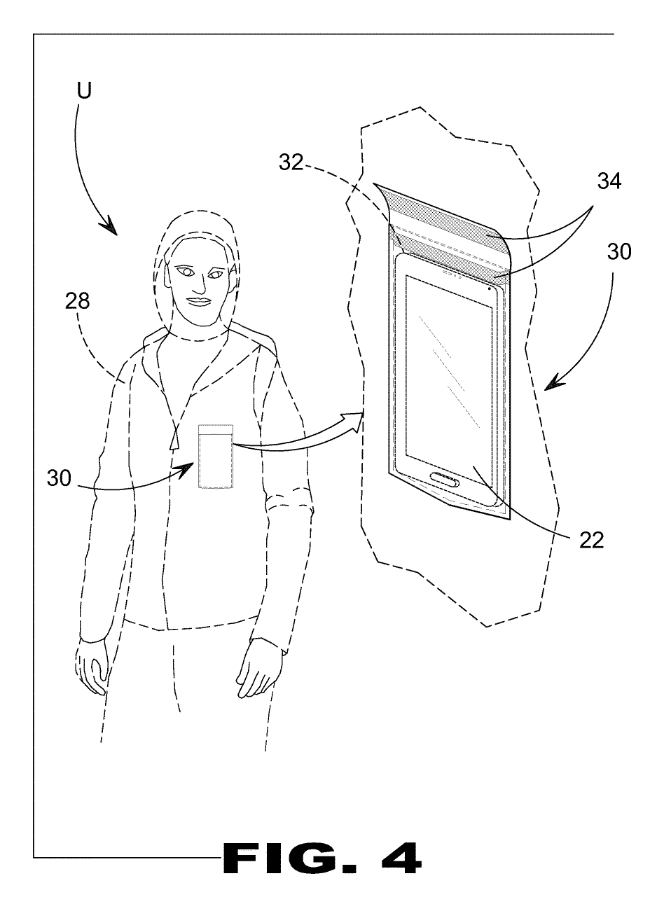

Referring to FIG. 4, shown is an illustrative view of one enablement of the present invention. In this Figure the present invention 20 provides a thermal pocket 30 with an inner area 32 and having a closure element 34 for winter apparel 28 where a cell phone or smart phone (or other type of battery-powered electronic device) 22 is placed therein having an exothermic device adhesively attached to the mobile device as seen in the previous Figure. A compartment for storing extra exothermic devices may be provided, which may also serve as an additional compartment for an activated thermal device 24 (not seen in this Figure) so that the mobile device and working exothermic device are in separate compartments.

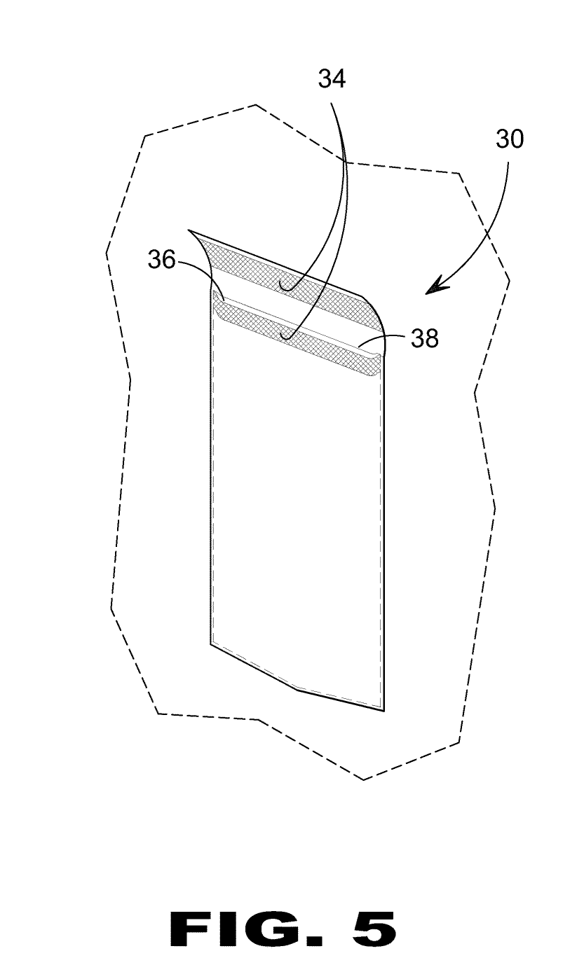

Referring to FIG. 5, shown is an illustrative view of a thermal pocket for providing supplemental heat for a mobile device or the like. A critical aspect of mobile device functionality is ambient temperature. Batteries and sensitive electronics are adversely affected by cold through the chemical process within batteries slowing as temperature drops resulting in insufficient current to power the device. Interestingly, in some cases, taking that same device which appear to have a dead battery and putting it in a warm environment may resuscitate the battery. The present invention envisions incorporating a thermal pocket for mobile devices into apparel or a bag, such as a backpack so that the ambient temperature of the phone (or other battery powered device) is kept above freezing (or to a desired temperature). The pocket seen in this Figure incorporates a mobile device receiving compartment indicated in this Figure at 36 and an exothermic device receiving pocket indicated at 38 as discussed above. The partition between the two pocket compartments may be manufactured from the same material as the pocket, from a thermally reflective material, or from a heat-retaining material.

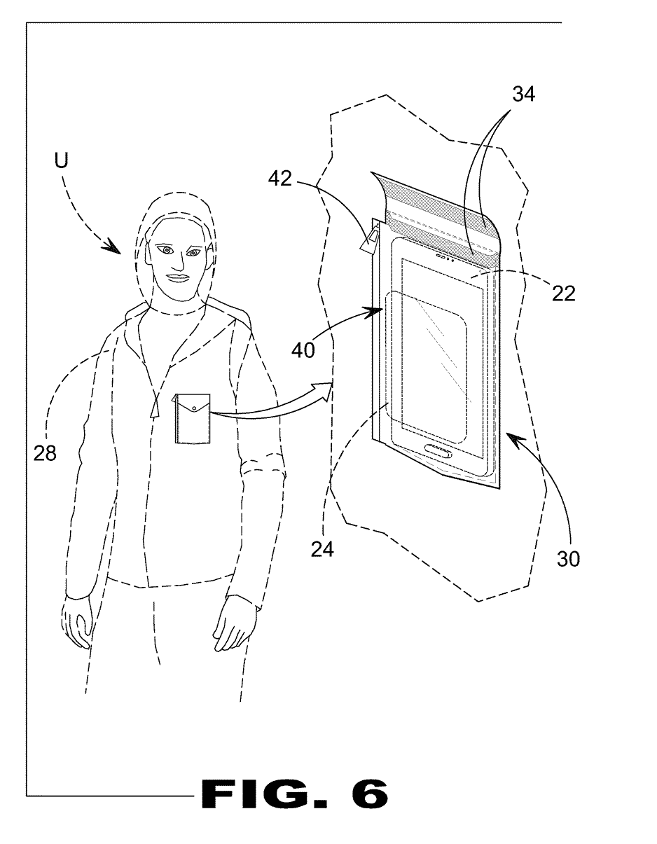

FIG. 6 shows another embodiment of the present invention. In this embodiment, the thermal pocket 30 includes a zippered side pocket 40 along with the main releasable closure 34, which could be hook and loop type fasteners, buttons, or another zipper. The securing zipper 42 for the zippered side pocket 40 is seen while the mobile device 22 or the like is placed within the thermal pocket 30. It should be noted that the zippered side pocket 40 could be modified to store additional warmers as needed.

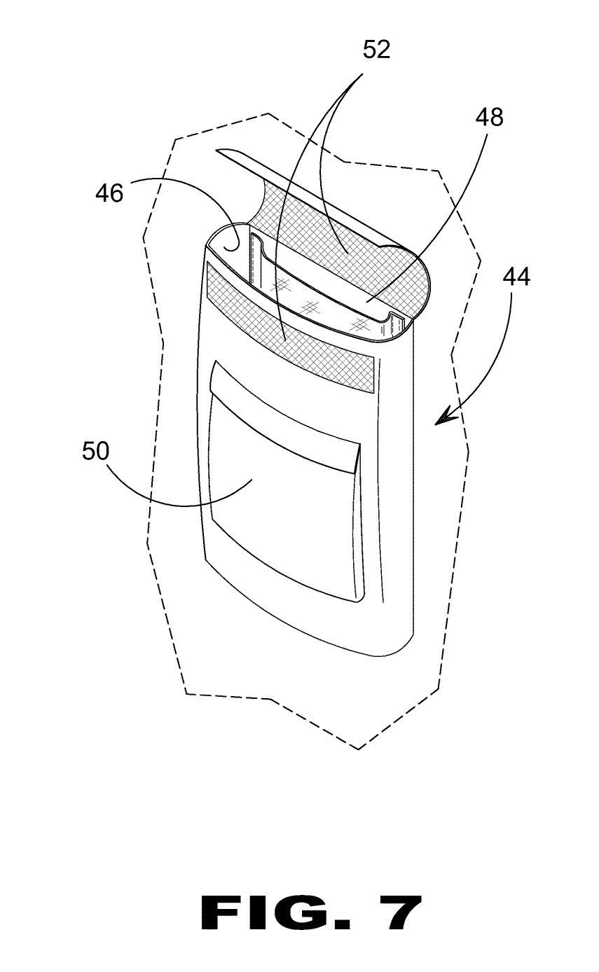

Referring to FIG. 7, shown is an illustrative view of another thermal pocket embodiment indicated at 44. In this embodiment, the pocket 44 includes a mobile device compartment 46, a warmer compartment 48, and an additional spare warmer compartment 50 for additional exothermic devices. Also seen in the Figure is a releasable closure 52. As above, this could be hook and loop type fasteners, buttons, zippers, or the like. The material that makes up the inner walls or compartment walls could be uniform, or parts could be either heat reflective or heat retaining material.

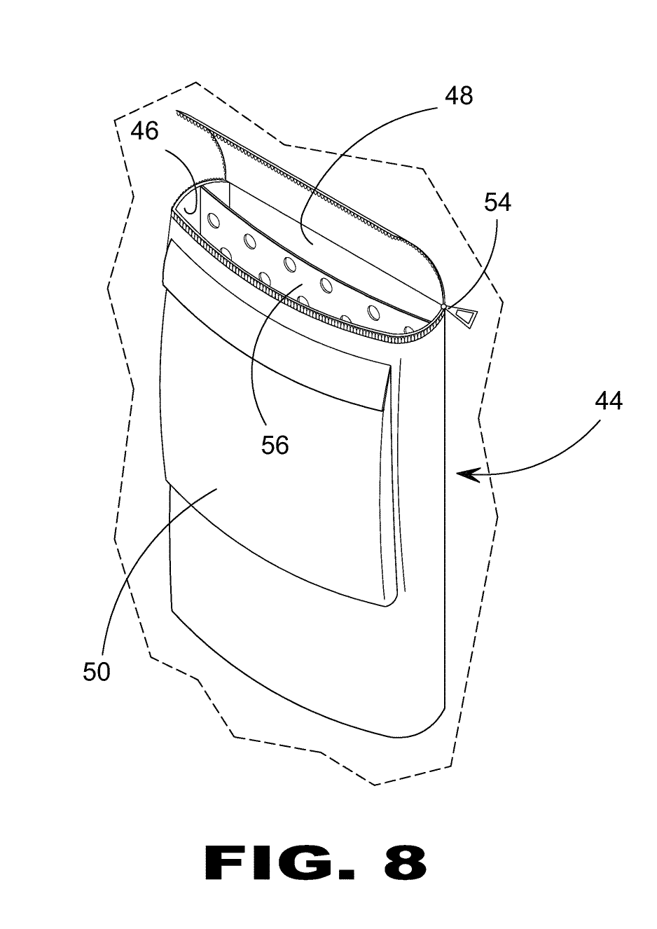

Referring to FIG. 8, shown is another illustrative view of the present invention in use. Shown is the thermal pocket 44 (similar to that shown in FIG. 7) for winter apparel having a closure element, in this case a top zipper type closure indicated at 54 and two divided chambers 46, 48 for securely holding a cell or smart phone (46) and exothermic device (48) therein. An additional pocket 50 is provided for the storage of extra exothermic devices. The inner dividing compartment wall 56 is shown as perforated to allow heat to flow between the two compartments 46, 48. AS mentioned above, the material making up this inner compartment wall 56 could be heat retaining, heat reflective, or a combination of the two.

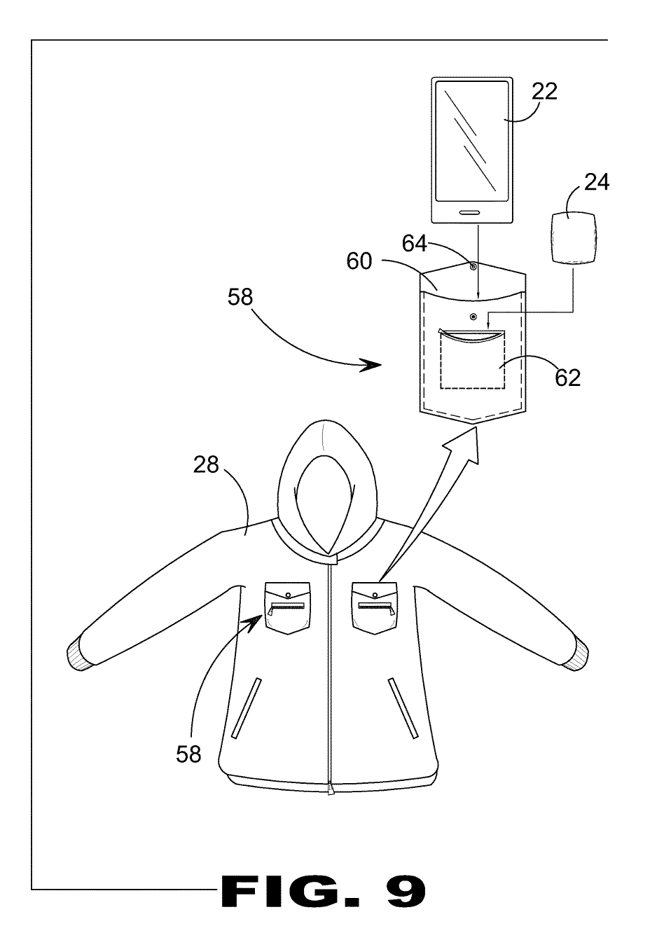

Referring to FIG. 9, shown is an illustrative view of another enablement of the present invention in use in a winter coat or parka 28. In this embodiment the cell phone or the like 22 is placed in a breast pocket compartment 60 while the exothermic device 24 is placed in the warmer pocket as indicated at 62. In this embodiment the device 22 is secured in the compartment 60 by a snap closure at 64.

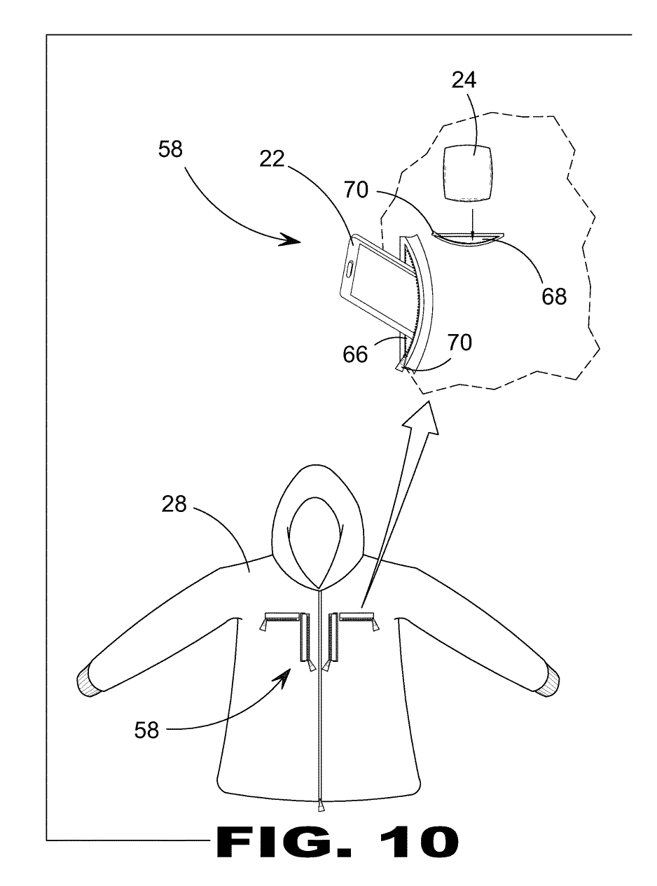

Referring to FIG. 10, shown is an illustrative view of an enablement of the present invention in use with another arrangement of the pockets 66, 68. The first phone pocket 66 is vertically oriented as shown and is secured by a parka zipper closure 70. Likewise closed by another parka zipper 70 is the horizontally oriented warmer pocket indicated at 68.

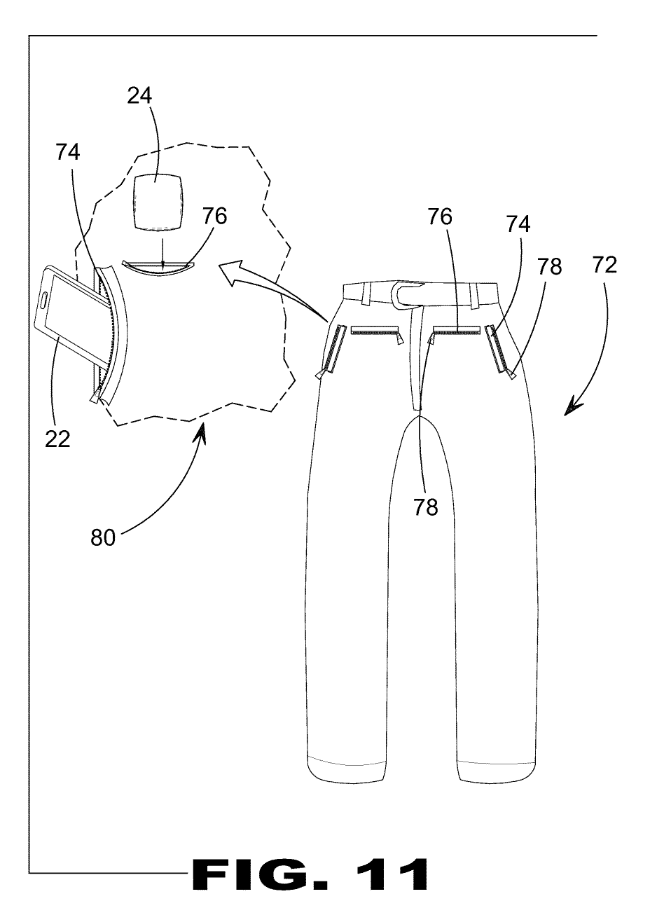

Referring to FIG. 11 an embodiment of the present invention is shown using snow pants or the like. The pants are indicated at 72 and they include a pair of snow pant pockets 80, each having a vertically oriented pant pocket for a phone or other electronic device 74, and a horizontally oriented pant pocket to contain the warmer indicated at 76. Both these pockets 74, 76 are secured by pant zipper closures 78. The proximity of the warmer pocket 76 and the electronic device pocket 74 allows the former to keep the latter warm as discussed above.

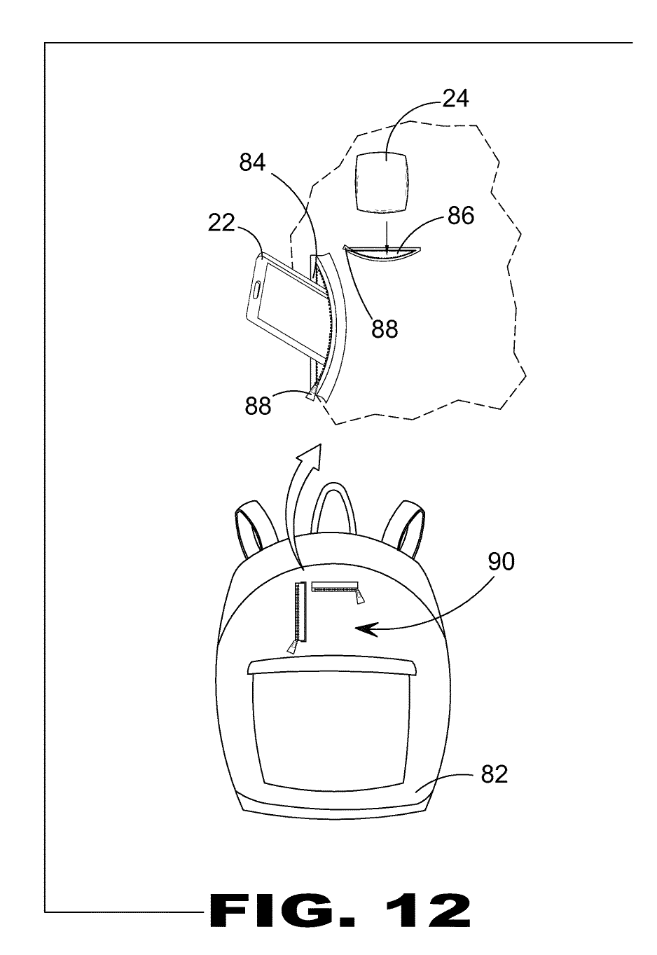

Referring to FIG. 12, shown is an illustrative view of an additional element of the present invention in use. Shown is a thermal backpack pocket 90 of the present invention incorporated into a back pack indicated at 82. The thermal backpack pocket includes a backpack phone compartment 84 and a backpack warmer compartment 86. Both of these are secured with backpack zipper closures as indicated at 88. As above, the proximity of the two compartments 84, 86 ensure that the battery in the electronic device stays warm.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

What is claimed is new and desired to be protected by Letters Patent is set forth in the appended claims:

1. A method for preventing temperature degradation in the battery of a mobile electronic device comprising the steps of:
providing a mobile electronic device having a battery;
providing an exothermic device;
providing a temporary device storage location;
placing said mobile electronic device and said exothermic device in proximity to one another;
placing said proximally located mobile electronic device and exothermic device in said temporary device storage location such that said exothermic device warms the battery-powered electronic device within said temporary device storage location.

2. The method for preventing temperature degradation in the battery of an mobile electronic device as claimed in claim 1 where said temporary device storage location is located in a piece of apparel.

3. The method for preventing temperature degradation in the battery of a mobile electronic device as claimed in claim 2 where said temporary storage location is a pocket.

4. The method for preventing temperature degradation in the battery of a mobile electronic device as claimed in claim 3 where said pocket is divided and where said battery-powered electronic device and said exothermic device are placed in separate locations in said divided pocket.

5. The method for preventing temperature degradation in the battery of a mobile electronic device as claimed in claim 4 where said pocket is located in a winter parka.

6. The method for preventing temperature degradation in the battery of a mobile electronic device as claimed in claim 4 where said pocket is located in a pair of snow pants.

7. The method for preventing temperature degradation in the battery of a mobile electronic device as claimed in claim 4 where said pocket is located in a backpack.

8. The method for preventing temperature degradation in the battery of a mobile electronic device as claimed in claim 3 where said divided pocket includes heat reflecting material.

9. The method for preventing temperature degradation in the battery of a mobile electronic device as claimed in claim 8 where said pocket is located in a winter parka.

10. The method for preventing temperature degradation in the battery of a mobile electronic device as claimed in claim 8 where said pocket is located in a pair of snow pants.

11. The method for preventing temperature degradation in the battery of a mobile electronic device as claimed in claim 8 where said pocket is located in a backpack.

12. The method for preventing temperature degradation in the battery of a mobile electronic device as claimed in claim 3 where said divided pocket includes heat retaining material.

13. The method for preventing temperature degradation in the battery of a mobile electronic device as claimed in claim 12 where said pocket is located in a winter parka.

14. The method for preventing temperature degradation in the battery of a mobile electronic device as claimed in claim 12 where said pocket is located in a pair of snow pants.

15. The method for preventing temperature degradation in the battery of a mobile electronic device as claimed in claim 12 where said pocket is located in a backpack.

16. A method for preventing temperature degradation in the battery of a mobile electronic device comprising the steps of:
providing a mobile electronic device having a battery;
providing a chemical exothermic device;
providing a temporary device storage location located in a piece of apparel and where said temporary device storage location is a pocket;
placing said mobile electronic device and said exothermic device in proximity to one another using an adhesive means;
placing said proximally located mobile electronic device and exothermic device in said temporary device storage location such that said exothermic device warms the battery-powered electronic device within said temporary device storage location.

17. The method for preventing temperature degradation in the battery of a mobile electronic device as claimed in claim 16 where said pocket is located in a winter parka.

18. The method for preventing temperature degradation in the battery of a mobile electronic device as claimed in claim 16 where said pocket is located in a pair of snow pants.

19. The method for preventing temperature degradation in the battery of a mobile electronic device as claimed in claim 16 where said pocket is located in a backpack.
